(19) United States
(12) Patent Application Publication
(10) Pub. No.: US 2016/0039329 A1
(43) Pub. Date: Feb. 11, 2016

(54) FLUID LEVEL DETECTION SYSTEM

(71) Applicant: International Truck Intellectual Property Company, Lisle, IL (US)

(72) Inventor: Tom Lee Sorensen, Naperville, IL (US)

(21) Appl. No.: 14/452,837

(22) Filed: Aug. 6, 2014

(51) Int. Cl. B60Q 1/00; G01F 23/00

(52) U.S. Cl. CPC B60Q 1/00; G01F 23/00

(57) ABSTRACT

A system for detecting a fluid in a container comprises a body control module and a circuit for detecting the fluid level in the container. The circuit includes a switch operatively connected with the container such that the switch is closed when fluid level in the container is low, a light emitting diode electrically connected with the switch and operatively connected with the container such that the light emitting diode illuminates the container; and a portion electrically connected with the switch and the light emitting diode. The portion enables selection between illuminating the container having a low fluid level and illuminating the container irrespective of fluid level in the container.

### BACKGROUND

This application generally relates to a system and a method for detecting fluid level in a container. More specifically, this application relates to a system and a method for detecting a fluid level in a container on a vehicle.

A vehicle, such as a vehicle with a compression combustion engine, often has a number of containers that contain fluid. Some examples of these fluids and associated containers include brake fluid, power steering fluid, coolant fluid, windshield washer fluid and the like. During operation of the vehicle, some of these fluids are moved from their containers, thereby reducing a volume of the fluid disposed in the container. For instance, windshield washer fluid is moved from a windshield washer fluid container and sprayed on a windshield. After sufficient operation of the vehicle, there may be insufficient windshield washer fluid in the windshield washer fluid container. An operator of the vehicle needs to add more windshield washer fluid to the windshield washer fluid container to continue operation of the vehicle.

In order to have substantially uninterrupted operation of a vehicle, the operator needs to be able to detect quickly and easily if more fluid needs to be added to a specific container. Many of the containers are made of a translucent material, making detection of a level of fluid in the container difficult. It is desirable to have a system and a method for detecting a fluid level in a container quickly and easily.

### SUMMARY

Disclosed herein are embodiments of systems and methods for detecting a fluid level in a container. In one embodiment, the system comprises a body control module and a circuit for detecting the fluid level in the container. The circuit includes a switch operatively connected with the container such that the switch is closed when fluid level in the container is low, a light emitting diode electrically connected with the switch and operatively connected with the container such that the light emitting diode illuminates the container; and a portion electrically connected with the switch and the light emitting diode. The portion enables selection between illuminating the container having a low fluid level and illuminating the container irrespective of fluid level in the container.

### DESCRIPTION OF THE DRAWINGS

FIG. 1 is a schematic diagram of an embodiment of a system for detecting fluid in a container;

FIG. 2 is a schematic diagram of another embodiment of a system for detecting fluid in a container;

FIG. 3 is a generic diagram of another embodiment of a system for detecting fluid in a container;

FIG. 4 is a generic diagram of another embodiment of a system for detecting fluid in a container; and

FIG. 5 is a generic diagram of another embodiment of a system for detecting fluid in a container.

### DETAILED DESCRIPTION

Disclosed herein are a number of embodiments of a system for detecting a fluid in a container. Also disclosed herein are a number of embodiments of a method for detecting a fluid in a container. It is to be recognized that elements of one embodiment can be exchanged with other elements of another embodiment to arrive at yet further embodiments. The embodiments may be utilized in any appropriate manner, such as detecting fluid in a container in a compression ignition engine and the like. For clarity of understanding, embodiments described in detail herein will be focused on utilization with a compression ignition engine.

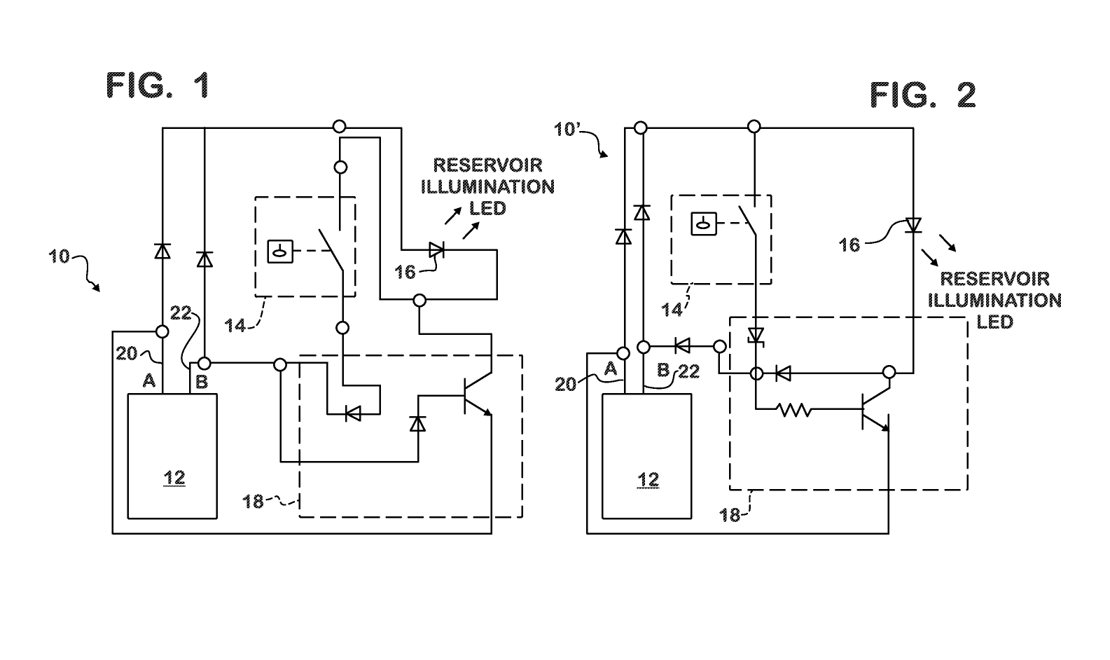

FIG. 1 is a schematic diagram of a circuit 10 for detecting a fluid level in a container located in an engine compartment of a vehicle (not shown for clarity). The circuit 10 can be extended to include multiple containers on the same vehicle. The circuit 10 extends from a body control module 12, or similar computer, on the vehicle. The circuit 10 includes a switch 14. The switch 14 is operatively connected with the container such that the switch 14 is closed when fluid level in the container is low. A light emitting diode 16 is operatively connected with the container and is electrically connected with the switch 14 such that electrical power is applied to the light emitting diode 16 when the switch 14 is closed. Thus, the light emitting diode 16 emits light when the switch 14 is closed, i.e. when fluid level in the container is low. The light emitting diode 16 illuminates the container.

The circuit 10 includes a portion 18 that can change potential on a pole of the body control module 12. The portion 18 is electrically connected with the switch 14 and the light emitting diode 16. In operation, one pole 20 of the body control module 12 has a potential of 5 Volts and another pole 22 of the body control module 12 is grounded. The light emitting diode 16 emits light when the switch 14 is in a closed position. The portion 18 is not activated. When the outputs of the body control module 12 are reversed and one pole 20 is ground and the another pole 22 has a potential of 5 Volts, then the portion 18 is activated and forces the light emitting diode 16 regardless of state or position (on or off) of the switch 14. In this case, the light emitting diode 16 emits light irrespective of position of the switch 14.

By reversing polarities of the body control module 18 outputs on one pole 20 and another pole 22, an operator of the vehicle can select between illuminating only a container having a low fluid level and illuminating a container on the vehicle irrespective of fluid level in the container. If multiple containers are included on one vehicle, the portion 18 allows an operator to select between illuminating only containers with low fluid levels and illuminating all containers on the vehicle with portion 18 applied respective of each container. The portion 18 changes potential applied to the light emitting diode 16 depending on signal output polarities of the body control module 12 or other means responsive to selection by an operator of the vehicle.

FIG. 2 is a schematic diagram of another embodiment of a circuit 10′ for detecting a fluid level in a container. The circuit 10′ is constructed substantially similarly to the circuit 10 of FIG. 1, hence the like reference numbers. Notably, the circuit 10′ accommodates a normally closed type switch (open when fluid level in the container is low).

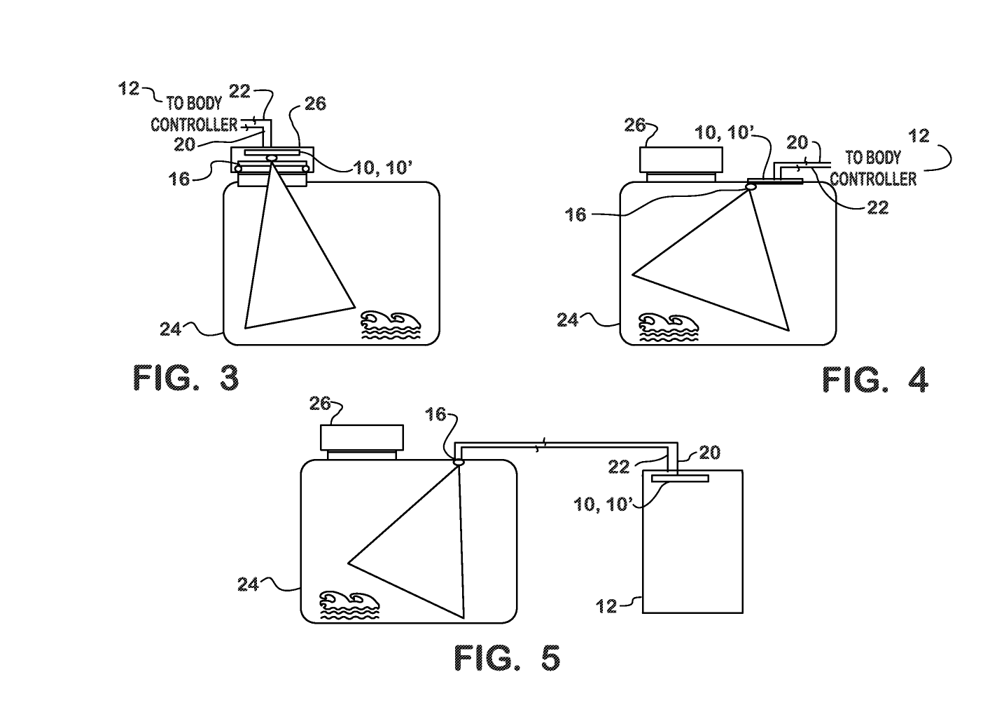

FIG. 3 illustrates an embodiment of a system for detecting fluid level in a container 24. The container 24 includes a cap 26. The cap 26 may be removable from the container 24 to allow access to an interior of the container 24. Such access may be used to add fluid to the container 24. The cap 26 includes the circuit 10, 10′. The circuit 10, 10′ may be embedded in the cap 26. The light emitting diode 16 is positioned on the cap 26 to illuminate an interior of the container 24.

FIG. 4 illustrates an embodiment of a system for detecting fluid level in a container 24. The circuit 10, 10′ is attached to an outer surface of the container 24. The light emitting diode 16 is operatively connected with the container 24 to illuminate an interior of the container 24. The light emitting diode 16 may be molded into a wall of the container 24 or positioned adjacent a surface of the container 24.

FIG. 5 illustrates an embodiment of a system for detecting fluid level in a container 24. The circuit 10, 10′ is located with the body control module 12. The light emitting diode 16 is operatively connected with the container 24. The light emitting diode 16 may be molded into a wall of the container 24 or positioned adjacent a surface of the container 24.

As FIGS. 3, 4 and 5 show, the light emitting diode 16 may be operatively connected with the cap 26 or with the container 24 so that the light emitting diode 16 illuminates the container 24 and allows detection of a fluid level within the container 24. The light emitting diode 16 may require a relatively low amount of electrical power and thereby generates a corresponding low amount of heat when illuminated. However, the construction of the light emitting diode 16 can be selected to enable an operator to identify an illuminated container 24 irrespective of ambient light.

Any of the embodiments described herein may be modified to detect fluid level in more than one container 24. For each container 24 in which fluid level is detected, a corresponding switch 14 and light emitting diode 16 are added. Generally, each container 24 in which fluid level is detected includes two wires to complete an electric circuit including a switch 14 and a light emitting diode 16.

With construction of the system for detecting fluid level in a container 24 being thusly described, methods of operation of the system will now be discussed.

An operator of a vehicle having a container 24 for fluid desires to check fluid level in the container 24. The operator activates the portion 18 selecting either illumination of the container 24 having a low fluid level or illumination of the container 24 irrespective of fluid level in the container 24. The operator approaches the engine compartment. The operator is able to see the illuminated container 24. Given illumination of the container 24 by the light emitting diode 16, the operator is able to determine if the fluid level in the container 24 is low. If the fluid level in the container 24 is low, the operator can access an interior of the container 24 by removing the cap 26. The operator adds sufficient fluid to the container 24 such that the fluid level in the container 24 is acceptable for further operation of the vehicle.

### REFERENCE CHARACTERS

10, 10′ Circuit
12 Body control module
14 Switch
16 Light emitting diode
18 Portion (of 10, 10′)
20 Pole (of 12)
22 Another pole (of 12)
24 Container
26 Cap

What is claimed is:

1. A system for detecting a fluid level in a container, the system comprising:
a body control module;
a circuit for detecting the fluid level in the container, the circuit including
a switch operatively connected with the container such that the switch is closed when fluid level in the container is low,
a light emitting diode electrically connected with the switch and operatively connected with the container such that the light emitting diode illuminates the container; and
a portion electrically connected with the switch and the light emitting diode, the portion enabling selection between illuminating the container having a low fluid level and illuminating the container irrespective of fluid level in the container.

2. The system as defined in claim 1 further comprising:
a cap on the container.

3. The system as defined in claim 1 further comprising:
a second container;
a second switch operatively connected with the second container such that the second switch is closed when fluid level in the second container is low; and
a second light emitting diode electrically connected with the second switch and operatively connected with the second container such that the second light emitting diode illuminates the second container, wherein the portion enables selection between illuminating the container having a low fluid level and the second container having a low fluid level, and illuminating the container and the second container irrespective of fluid level of the container and the second container.
